(19) United States
(12) Patent Application Publication
(10) Pub. No.: US 2025/0379242 A1
(43) Pub. Date: Dec. 11, 2025

(54) ION EXCHANGER

(71) Applicant: TOYOTA BOSHOKU KABUSHIKI KAISHA, Aichi-ken (JP)

(72) Inventors: Toshihiko TANAHASHI, Nagoya-shi (JP); Shingo YABE, Obu-shi (JP); Satoshi KAWABE, Ichinomiya-shi (JP)

(73) Assignee: TOYOTA BOSHOKU KABUSHIKI KAISHA, Aichi-ken (JP)

(21) Appl. No.: 19/226,827

(22) Filed: Jun. 3, 2025

(30) Foreign Application Priority Data
Jun. 11, 2024 (JP) 2024-094639

(51) Int. Cl. H01M 8/04029; H01M 8/04746

(52) U.S. Cl. CPC H01M 8/04029; H01M 8/04768

(57) ABSTRACT

An ion exchanger includes containers arranged next to one another, ion exchange resin portions contained in the containers, respectively, and an inlet pipe extending in an arrangement direction of the containers. Each of the containers has a bottom wall. The inlet pipe includes connection passages arranged in correspondence with the containers, a first tapered portion, and a second tapered portion. The inlet pipe has a cross-sectional flow area having a decrease degree that is greater in the second tapered portion than in the first tapered portion. The second tapered portion is in communication with a container of the containers that is located at the most downstream side in the flow direction via a corresponding one of the connection passages.

### CROSS-REFERENCE TO RELATED APPLICATIONS

This application is based upon and claims the benefit of priority from Japanese Patent Application No. 2024-094639, filed on Jun. 11, 2024, the entire contents of which are incorporated herein by reference.

### BACKGROUND

### 1. Field

The present disclosure relates to an ion exchanger.

### 2. Description of Related Art

In a conventional fuel cell, coolant circulates through the inside of the fuel cell to limit increases in the temperature of the fuel cell when generating power. As the fuel cell generates power, ions may be released into the coolant. As a result, the conductivity of the coolant increases. The resultant coolant may cause electric leakage and adversely affect the function of the fuel cell. Hence, the fuel cell is connected to an ion exchanger that allows the coolant to flow through ion exchange resin so that ions are removed from the coolant.

Japanese Laid-Open Patent Publication No. 2003-229152 describes an ion exchanger that includes a case and cartridges configured to be removably attached to the case. The cartridges are filled with ion exchange resin.

The case includes cartridge accommodation spaces arranged next to one another and configured to accommodate the cartridges, respectively. An inlet passage and an outlet passage are respectively formed in a lower portion and an upper portion of the case. The inlet passage extends in an arrangement direction of the cartridge accommodation spaces and is in communication with a lower portion of each cartridge accommodation space. The outlet passage extends in the arrangement direction of the cartridge accommodation spaces and is in communication with an upper portion of each cartridge accommodation space.

When the coolant flows into the inlet passage, the coolant flows from the lower portion toward the upper portion of the case. Then, the coolant is discharged to the outside of the case through the outlet passage. In this process, the coolant flows through the ion exchange resin of each cartridge, so that ions are removed from the coolant.

In the ion exchanger described in the above publication, in the inlet passage, the coolant flows in the arrangement direction of the cartridge accommodation spaces, whereas in the cartridges, the coolant flows from the lower side toward the upper side. In other words, when the coolant flows from the inlet passage toward each cartridge, the flow direction of the coolant changes. Due to inertial force, the coolant flowing through the inlet passage is more likely to flow toward the downstream side of the inlet passage than toward the cartridge. In this case, the flow rate of the coolant tends to be increased in the cartridges arranged further downstream of the inlet passage. Therefore, the ion exchange resin tends to deteriorate more quickly in the cartridges arranged further downstream of the inlet passage. As a result, the flow rate of the coolant tends to increase in the cartridges in which the ion exchange resin deteriorates more quickly. This may decrease the ion exchanging efficiency of the ion exchanger.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, an ion exchanger includes containers arranged next to one another, ion exchange resin portions contained in the containers, respectively, and an inlet pipe extending in an arrangement direction of the containers and being configured to allow a coolant to flow to the containers. A direction of the coolant flowing through the inlet pipe is referred to as a flow direction. Each of the containers has a bottom wall. The inlet pipe includes connection passages arranged in correspondence with the containers, each of the connection passages being open through the bottom wall of a corresponding one of the containers to allow for communication between an inner space of the inlet pipe and an inner space of the corresponding one of the containers in a radial direction of the inlet pipe, a first tapered portion having a cross-sectional flow area that decreases toward a downstream side in the flow direction, and a second tapered portion arranged at the downstream side of the first tapered portion and having a cross-sectional flow area that decreases toward the downstream side. The inlet pipe has a cross-sectional flow area having a decrease degree that is greater in the second tapered portion than in the first tapered portion. The second tapered portion is in communication with a container of the containers that is located at the most downstream side in the flow direction via a corresponding one of the connection passages.

Other features and aspects will be apparent from the following detailed description, the drawings, and the claims.

### BRIEF DESCRIPTION OF THE DRAWINGS

FIG. 1 is a perspective view showing an embodiment of an ion exchanger.

FIG. 2 is a cross-sectional view showing an inlet pipe of the ion exchanger shown in FIG. 1.

FIG. 3 is a cross-sectional perspective view showing a case of the ion exchanger shown in FIG. 1.

FIG. 4 is a cross-sectional view taken along line 4-4 in FIG. 3.

FIG. 5 is a cross-sectional view showing an outlet pipe in the ion exchanger shown in FIG. 1.

FIG. 6A is a cross-sectional view showing a state before resin is injected into a cavity that forms the inlet pipe, and FIG. 6B is a cross-sectional view showing a state after the resin is injected into the cavity.

FIG. 7A is a cross-sectional view showing a state before resin is injected into a cavity that forms the outlet pipe, and FIG. 7B is a cross-sectional view showing a state after the resin is injected into the cavity.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

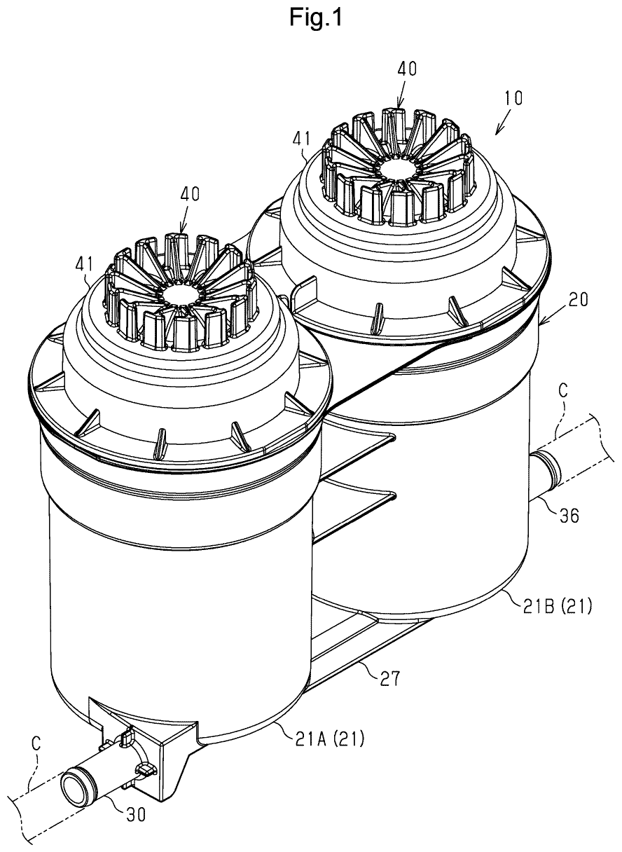

An embodiment of an ion exchanger will now be described with reference to FIGS. 1 to 7B.

### Overall Structure of Ion Exchanger 10

FIG. 1 shows an example of an ion exchanger 10 that includes a coolant circuit C through which a coolant flows to cool a fuel cell. The ion exchanger 10 removes ions from the coolant.

The ion exchanger 10 includes a case 20 and two cartridges 40. Each cartridge 40 is configured to be removably attached to the case 20.

### Overall Structure of Case 20

The case 20 includes two containers 21, a joint portion 27, an inlet pipe 30, and an outlet pipe 36. The two containers 21 are arranged next to each other and spaced apart from each other. The joint portion 27 joins the two containers 21. The inlet pipe 30 allows the coolant to flow into the two containers 21. The outlet pipe 36 allows the coolant to flow out from the two containers 21. The case 20 is formed of, for example, a thermoplastic resin material.

### Structure of Container 21

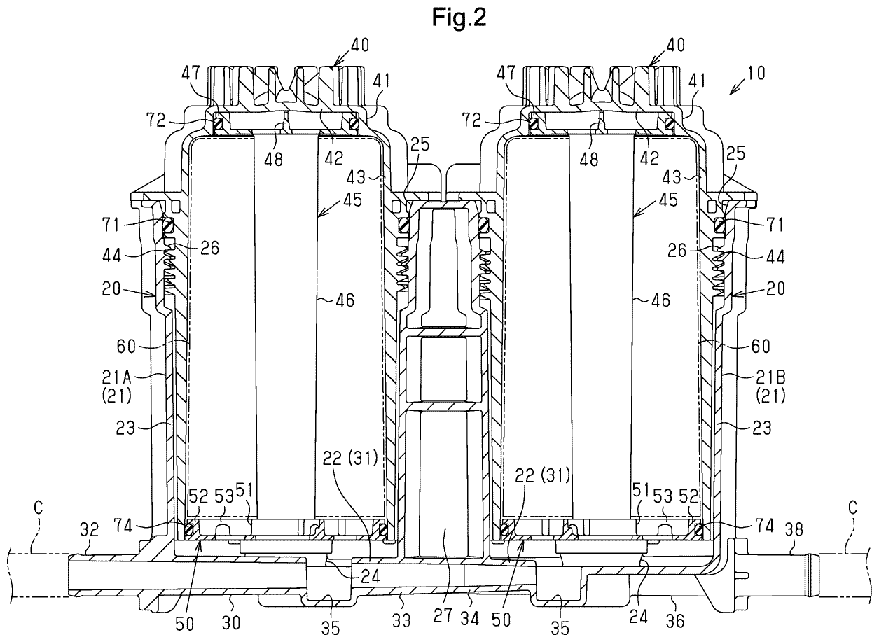

As shown in FIG. 2, each container 21 has a bottom wall 22, a circumferential wall 23, and a protrusion 24. The bottom wall 22 is circular in plan view. The circumferential wall 23 projects upward from the circumferential edge of the bottom wall 22. The protrusion 24 protrudes upward from the circumference of the center of the bottom wall 22. The protrusion 24 is annular and surrounds the center of the bottom wall 22 along the entire circumference. The circumferential walls 23 of the two containers 21 are joined by the joint portion 27.

An insertion opening 25 is formed in an end of the circumferential wall 23 located at a side opposite from the bottom wall 22 to allow for insertion of the cartridge 40 into the container 21. The insertion opening 25 is open upward. That is, the container 21 has the shape of a cylinder having a closed lower end. An internal thread 26 is formed on an inner wall surface of the insertion opening 25.

### Structure of Inlet Pipe 30

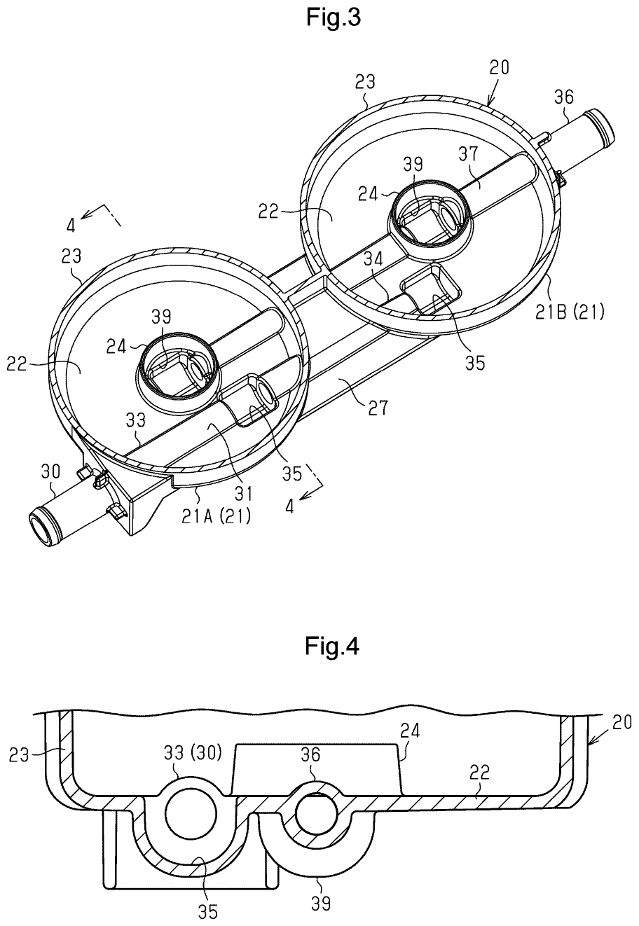

As shown in FIG. 3, the inlet pipe 30 extends linearly in the arrangement direction of the two containers 21 under the two containers 21. The inlet pipe 30 extends parallel to an imaginary line connecting the centers of the bottom walls 22 of the two containers 21 and is separated from the imaginary line in a planar direction of the bottom walls 22. The inlet pipe 30 includes a flow passage having a circular cross section orthogonal to a longitudinal direction of the inlet pipe 30.

As shown in FIG. 2, the inlet pipe 30 is formed integrally with the bottom walls 22. The inner space of the inlet pipe 30 is separated from the inner space of each container 21 by only the bottom wall 22. In other words, the inlet pipe 30 has a circumferential wall 31 forming a portion of the bottom wall 22. The circumferential wall 31 of the inlet pipe 30 is exposed to the inner space of the container 21.

The inlet pipe 30 includes a first connection port 32 connected to the coolant circuit C. The first connection port 32 projects from the container 21 to an outer circumferential side of the container 21. The coolant flowing through the coolant circuit C flows into the inlet pipe 30 through the first connection port 32.

In the description hereafter, a direction of the coolant flowing through the inlet pipe 30 is referred to as a flow direction. Further, for distinction between the two containers 21, the container 21 located at the upstream side in the flow direction may be referred to as a container 21A, and the container 21 located at the downstream side may be referred to as a container 21B. The container 21B is located at the most downstream side in the flow direction.

The inlet pipe 30 includes a first tapered portion 33 and a second tapered portion 34. The first tapered portion 33 and the second tapered portion 34 each have a cross-sectional flow area that decreases toward the downstream side in the flow direction. The second tapered portion 34 is arranged at the downstream side of the first tapered portion 33 and is continuous with the first tapered portion 33. A decrease degree of the cross-sectional flow area of the inlet pipe 30 is greater in the second tapered portion 34 than in the first tapered portion 33. The “decrease degree of the cross-sectional flow area” refers to the degree of inclination of the inner surface of the flow passage with respect to the axis of the flow passage.

The first tapered portion 33 is a portion of the inlet pipe 30 in which the circumferential wall 31 is formed of the bottom wall 22 of the container 21A. The portion of the inlet pipe 30 in which the circumferential wall 31 is formed of the bottom wall 22 of the container 21A has a uniform thickness. In other words, an inner surface of the bottom wall 22 of the container 21A defining an outer circumferential surface of the first tapered portion 33 is inclined with respect to the axis of the inlet pipe 30 and extends along an inner circumferential surface of the first tapered portion 33.

The second tapered portion 34 is a portion of the inlet pipe 30 in which the circumferential wall 31 is formed of the bottom wall 22 of the container 21B. The portion of the inlet pipe 30 in which the circumferential wall 31 is formed of the bottom wall 22 of the container 21B has a uniform thickness. In other words, an inner surface of the bottom wall 22 of the container 21B defining an outer circumferential surface of the second tapered portion 34 is inclined with respect to the axis of the inlet pipe 30 and extends along an inner circumferential surface of the second tapered portion 34.

The boundary portion between the first tapered portion 33 and the second tapered portion 34 in the inlet pipe 30 is located between the two containers 21. The boundary portion between the first tapered portion 33 and the second tapered portion 34 is partially formed of the joint portion 27.

As shown in FIG. 3, the inlet pipe 30 has two inlet connection passages 35 arranged in correspondence with the two containers 21. The inlet connection passages 35 are each open through the bottom wall 22 of a corresponding one of the containers 21. Each inlet connection passage 35 allows for communication between the inner space of the inlet pipe 30 and the inner space of the container 21 in the radial direction of the inlet pipe 30. The inlet connection passage 35 includes a through hole extending through the circumferential wall 31 of the inlet pipe 30. The inner spaces of the two inlet connection passages 35 are identical in shape and size to each other. The opening of the inlet connection passage 35 in the bottom wall 22 is quadrangular in plan view. The inlet connection passage 35 is an example of a “connection passage.”

The inlet connection passage 35 that is open through the bottom wall 22 of the container 21A is arranged in a longitudinal intermediate part of the first tapered portion 33 at a position offset from the center of the bottom wall 22. Thus, the first tapered portion 33 is in communication with the container 21A via the inlet connection passage 35.

The inlet connection passage 35 that is open through the bottom wall 22 of the container 21B is arranged continuous with the distal end of the second tapered portion 34 at a position offset from the center of the bottom wall 22. That is, the second tapered portion 34 is in communication with the container 21B via the inlet connection passage 35.

As shown in FIG. 4, the inner space of each inlet connection passage 35 extends further outward in the radial direction than the inner space of the first tapered portion 33 and the inner space of the second tapered portion 34. The inlet connection passage 35 is bulged downward from the bottom wall 22 and is dome-shaped. The cross section of the inlet connection passage 35 orthogonal to the flow direction is uniform in shape and size in the flow direction.

### Structure of Outlet Pipe 36

As shown in FIG. 3, the outlet pipe 36 extends linearly in the arrangement direction of the two containers 21 under the two containers 21. The outlet pipe 36 extends on an imaginary line connecting the centers of the bottom walls 22 of the two containers 21. The outlet pipe 36 extends parallel to the inlet pipe 30. The outlet pipe 36 includes a flow passage having a circular cross section orthogonal to a longitudinal direction of the outlet pipe 36.

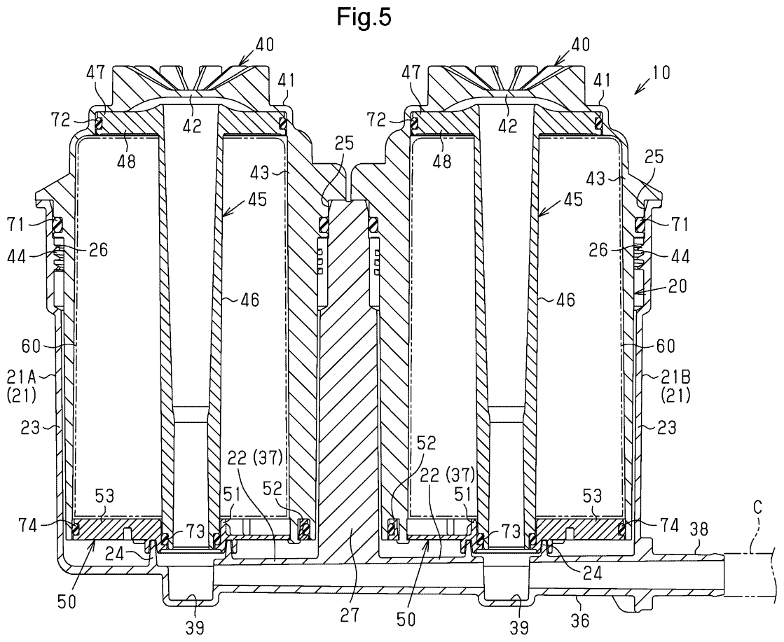

As shown in FIG. 5, the outlet pipe 36 is formed integrally with the bottom walls 22. The inner space of the outlet pipe 36 is separated from the inner space of each container 21 by only the bottom wall 22. In other words, the outlet pipe 36 has a circumferential wall 37 forming a portion of the bottom wall 22. The circumferential wall 37 of the outlet pipe 36 is exposed to the inner space of the container 21.

The outlet pipe 36 includes a second connection port 38 connected to the coolant circuit C. The second connection port 38 projects from the container 21 to an outer circumferential side of the container 21. The coolant flowing through the outlet pipe 36 flows into the coolant circuit C via the second connection port 38.

The second connection port 38 of the outlet pipe 36 is oriented oppositely from the first connection port 32 of the inlet pipe 30 in the arrangement direction of the two containers 21. Thus, the coolant flowing through the outlet pipe 36 flows in the same direction as the coolant flowing through the inlet pipe 30. Hence, in the description hereafter, in addition to the direction of the coolant flowing through the inlet pipe 30, the direction of the coolant flowing through the outlet pipe 36 is also simply referred to as the flow direction.

The cross-sectional flow area of the outlet pipe 36 increases toward the downstream side in the flow direction. In other words, the cross-sectional flow area of the outlet pipe 36 decreases toward the upstream side in the flow direction. The decrease degree of the cross-sectional flow area of the outlet pipe 36 is, for example, the same as the decrease degree of the cross-sectional flow area of the inlet pipe 30 in the first tapered portion 33.

The portion of each bottom wall 22 forming the circumferential wall 37 of the outlet pipe 36 has a uniform thickness. In other words, an inner surface of the bottom wall 22 defining an outer circumferential surface of the outlet pipe 36 is inclined from the axis of the outlet pipe 36 and extends along an inner circumferential surface of the outlet pipe 36. The bottom wall 22 includes a general portion that differs from the portions forming the inlet pipe 30 and the outlet pipe 36. The inner surface of the general portion of the bottom wall 22 is flat and is parallel to the axis of the inlet pipe 30 and the outlet pipe 36.

As shown in FIG. 3, the outlet pipe 36 has two outlet connection passages 39 arranged in correspondence with the two containers 21. The outlet connection passages 39 are each open through the bottom wall 22 of a corresponding one of the containers 21. Each outlet connection passage 39 allows for communication between the inner space of the outlet pipe 36 and the inner space of the container 21 in the radial direction of the outlet pipe 36. The outlet connection passage 39 includes a through hole extending through the circumferential wall 37 of the outlet pipe 36. The inner spaces of the two outlet connection passages 39 are identical in shape and size to each other. The inner space of each outlet connection passage 39 is identical in shape and size to the inner space of each inlet connection passage 35. The opening of the outlet connection passage 39 in the bottom wall 22 is quadrangular in plan view. The opening of the outlet connection passage 39 is surrounded by the protrusion 24.

The outlet connection passage 39 that is open through the bottom wall 22 of the container 21A is arranged in the center of the bottom wall 22 at the basal end of the outlet pipe 36. The outlet connection passage 39 that is open through the bottom wall 22 of the container 21B is arranged in the center of the bottom wall 22 at a longitudinal intermediate part of the outlet pipe 36.

The inner space of each outlet connection passage 39 extends further outward in the radial direction than the inner space of the remaining portion of the outlet pipe 36. The outlet connection passage 39 is bulged downward from the bottom wall 22 and is dome-shaped. The cross section of the outlet connection passage 39 orthogonal to the flow direction is uniform in shape and size in the flow direction.

### Overall Structure of Cartridge 40

As shown in FIGS. 2 and 5, the cartridge 40 includes a cap 41, a passage member 45, a cover member 50, and an ion exchange resin portion 60. The cap 41 is accommodated in the container 21 through the insertion opening 25. The passage member 45 forms a passage through which the coolant flows inside the cap 41. The cover member 50 is joined to the cap 41. The ion exchange resin portion 60 is accommodated inside the cap 41. The cap 41, the passage member 45, and the cover member 50 are formed of, for example, a thermoplastic resin material.

### Structure of Cap 41

The cap 41 includes a top wall 42 and a circumferential wall 43. The top wall 42 is circular in plan view. The circumferential wall 43 projects downward from the circumferential edge of the top wall 42. The cap 41 has the form of a round tube having a closed upper end.

An external thread 44 is formed on an outer circumferential surface of the circumferential wall 43 to mesh with the internal thread 26 of the container 21. The cap 41 is thread-coupled to the container 21 so that the cartridge 40 is removably attached to the case 20.

A first seal ring 71 is attached to a portion of the outer circumferential surface of the circumferential wall 43 located above the external thread 44. The first seal ring 71 seals the gap between the outer circumferential surface of the cap 41 and the inner circumferential surface of the container 21.

### Structure of Passage Member 45

The passage member 45 includes a pipe 46, an annular part 47, and first supports 48.

The pipe 46 has the form of a round tube vertically extending in the center of the inside of the cap 41. The pipe 46 includes an upper end that is open toward the inner surface of the top wall 42. The upper end of the pipe 46 is spaced apart from the top wall 42. The pipe 46 includes a lower end that is open toward the outlet connection passage 39. The lower end of the pipe 46 is located at an inner side of the protrusion 24.

The annular part 47 is ring-shaped and surrounds the upper end of the pipe 46. The annular part 47 is fitted into the upper end of the cap 41.

The first supports 48 connect the outer circumferential surface of the pipe 46 and the inner circumferential surface of the annular part 47 at intervals in the circumferential direction of the pipe 46.

A second seal ring 72 is attached to the outer circumferential surface of the annular part 47. The second seal ring 72 seals the gap between the outer circumferential surface of the annular part 47 and the inner circumferential surface of the cap 41.

A disc-shaped mesh member is formed integrally with the passage member 45 by insert molding. The mesh member is formed of, for example, a thin plate of metal such as stainless steel. The mesh member covers the lower surface of the annular part 47 and the lower surfaces of the first supports 48. The mesh member has through holes extending through the mesh member in the thickness direction. The through holes are sized to allow for passage of the coolant while hampering passage of the ion exchange resin portion 60.

### Structure of Cover Member 50

The cover member 50 includes an inner annular part 51, an outer annular part 52, and second supports 53.

As shown in FIG. 5, the inner annular part 51 is ring-shaped and surrounds the lower end of the pipe 46. The lower end of the inner annular part 51 is located at an inner side of the protrusion 24.

The outer annular part 52 is ring-shaped and surrounds the inner annular part 51. The outer annular part 52 is fitted into the lower end of the cap 41 and is joined to the cap 41.

The second supports 53 connect the outer circumferential surface of the inner annular part 51 and the inner circumferential surface of the outer annular part 52 at intervals in the circumferential direction of the inner annular part 51.

A third seal ring 73 is attached to the inner circumferential surface of the inner annular part 51. The third seal ring 73 seals the gap between the inner circumferential surface of the inner annular part 51 and the outer circumferential surface of the pipe 46.

A fourth seal ring 74 is attached to the outer circumferential surface of the outer annular part 52. The fourth seal ring 74 seals the gap between the outer circumferential surface of the outer annular part 52 and the inner circumferential surface of the cap 41.

A disc-shaped mesh member is formed integrally with the cover member 50 by insert molding. The mesh member covers the lower surface of the cover member 50. The mesh member has the same structure as the mesh member integrally formed with the passage member 45.

### Structure of Ion Exchange Resin Portion 60

The ion exchange resin portion 60 fills an area inside of the cap 41 around the pipe 46 between the annular part 47 and the cover member 50.

The coolant flowing from the inlet pipe 30 into the container 21 through the inlet connection passage 35 passes through the mesh member integrated with the cover member 50 and then reaches the region in the cap 41 filled with the ion exchange resin portion 60. As the coolant passes through the ion exchange resin portion 60, ions are removed from the coolant as a result of ion exchange of the ion exchange resin portion 60. After passing through the ion exchange resin portion 60, the coolant passes through the mesh member formed integrally with the passage member 45, and then flows into the pipe 46 through the opening in the upper end of the pipe 46. Then, the coolant flows into the outlet pipe 36 from the lower end of the pipe 46, and then flows out to the coolant circuit C from the outlet pipe 36.

### Method for Manufacturing Case 20

A method for manufacturing the case 20 will now be described.

The method for manufacturing the case 20 includes a molding step of injecting resin R into a cavity 80a in a mold unit 80 to integrally form the two containers 21, the inlet pipe 30, and the outlet pipe 36.

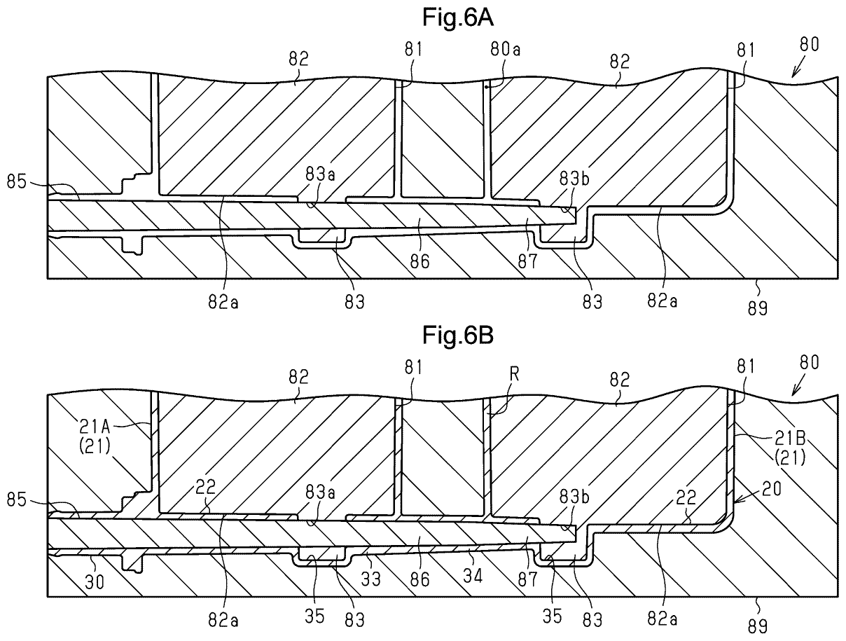

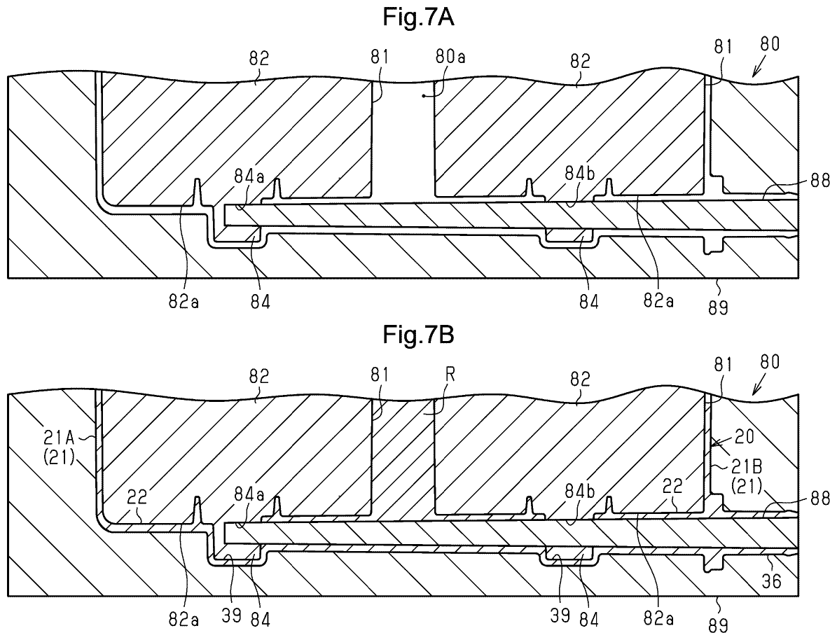

As shown in FIGS. 6A and 7A, the mold unit 80 includes two first molds 81, a second mold 85, a third mold 88, and a fourth mold 89. The first molds 81 form the inner surface of each container 21. The second mold 85 forms the inner surface of the inlet pipe 30. The third mold 88 forms the inner surface of the outlet pipe 36. The fourth mold 89 forms the outer surface of the case 20.

The first molds 81 each include a first molding portion 82 and two second molding portions 83 and 84. The first molding portion 82 forms the inner surface of the container 21. The second molding portion 83 forms the inner surface of the inlet connection passage 35. The second molding portion 84 forms the inner surface of the outlet connection passage 39.

The first molding portion 82 includes a molding surface 82a forming the inner surface of the bottom wall 22. A portion of the molding surface 82a extends along a peripheral surface of the second mold 85 so that the width of the cavity 80a formed between the molding surface 82a and the peripheral surface of the second mold 85, that is, a vertical gap, is uniform. Further, another portion of the molding surface 82a extends along a peripheral surface of the third mold 88 so that the width of the cavity 80a formed between the molding surface 82a and the peripheral surface of the third mold 88, that is, a vertical gap, is uniform.

As shown in FIGS. 6A and 6B, the second molding portions 83 project downward from the molding surfaces 82a. Each second molding portion 83 is configured to hold the second mold 85 when the second mold 85 is fitted to the second molding portion 83. More specifically, the second molding portion 83 of the first mold 81 for forming the inner surface of the container 21A has a fitting hole 83a into which the second mold 85 is fitted. The second molding portion 83 of the first mold 81 for forming the inner surface of the container 21B has a fitting recess 83b into which the distal end of the second mold 85 is fitted. The second mold 85 and the fitting recess 83b have an insertion-fitting structure.

As shown in FIGS. 7A and 7B, the second molding portions 84 project downward from the molding surface 82a. Each second molding portion 84 is configured to hold the third mold 88 when the third mold 88 is fitted to the second molding portion 84. More specifically, the second molding portion 84 of the first mold 81 for forming the inner surface of the container 21A has a fitting recess 84a into which the distal end of the third mold 88 is fitted. The second molding portion 84 of the first mold 81 for forming the inner surface of the container 21B has a fitting hole 84b into which the third mold 88 is fitted. The third mold 88 and the fitting recess 84a have an insertion-fitting structure.

As shown in FIGS. 6A and 6B, the second mold 85 has a columnar shape corresponding to the shape of the inlet pipe 30. The second mold 85 includes a first taper molding portion 86 and a second taper molding portion 87. The first taper molding portion 86 forms the inner surface of the first tapered portion 33. The second taper molding portion 87 forms the inner surface of the second tapered portion 34. The first taper molding portion 86 and the second taper molding portion 87 have a cross-sectional area orthogonal to a longitudinal direction of the second mold 85 that decreases toward the distal end of the second mold 85. The second taper molding portion 87 is arranged continuously with the distal end of the first taper molding portion 86. The decrease degree of the cross-sectional area of the second taper molding portion 87 is greater than the decrease degree of the cross-sectional area of the first taper molding portion 86.

When the second mold 85 is fitted to the second molding portions 83, the first taper molding portion 86 is fitted to the fitting hole 83a, and the distal end of the second taper molding portion 87 is fitted into the fitting recess 83b.

As shown in FIGS. 7A and 7B, the third mold 88 has a columnar shape corresponding to the shape of the outlet pipe 36. The third mold 88 has a cross-sectional area orthogonal to a longitudinal direction of the third mold 88 that decreases toward the distal end of the third mold 88.

The fourth mold 89 is, for example, a split mold that is split into multiple parts. The fourth mold 89 forms a cavity 80a for forming the case 20 between each first mold 81, the second mold 85, and the third mold 88.

As shown in FIG. 6A and FIG. 7A, in the molding step, the mold unit 80 is clamped to form a cavity 80a between each first mold 81, the second mold 85, the third mold 88, and the fourth mold 89.

As shown in FIG. 6B and FIG. 7B, in the molding step, the molten resin R is injected into the cavity 80a in the mold unit 80 when the second mold 85 is fitted to the second molding portions 83 and the third mold 88 is fitted to the second molding portions 84.

Subsequently, the mold unit 80 is cooled to cure the resin R in the cavity 80a. This forms the case 20. The formed case 20 is removed from the mold unit 80 when opened.

As shown in FIG. 6B, in the molding step, the second molding portions 83 form the two inlet connection passages 35, which are identical in shape and size to each other. In other words, the molding step forms an inlet connection passage 35 that allows for communication between the inner space of the first tapered portion 33 and the inner space of the container 21A and another inlet connection passages 35 that allows for communication between the inner space of the second tapered portion 34 and the inner space of the container 21B.

As shown in FIG. 7B, in the molding step, the second molding portions 84 form the two outlet connection passages 39, which are identical in shape and size to each other. In other words, the forming step forms the two outlet connection passages 39 that allow for communication between the inner space of the outlet pipe 36 and the inner spaces of the containers 21A and 21B, respectively.

### Operation of the Present Embodiment

The second tapered portion 34 of the inlet pipe 30 is in communication with the container 21B via the inlet connection passage 35. The decrease degree of the cross-sectional flow area of the inlet pipe 30 is greater in the second tapered portion 34 than in the first tapered portion 33. Thus, the flow rate of the coolant flowing through the inlet pipe 30 is lower in the second tapered portion 34 than in the first tapered portion 33. With this structure, the flow rate of the coolant flowing into the container 21B is decreased as compared to a structure in which the inlet pipe 30 includes only the first tapered portion 33 or a structure in which the inlet pipe 30 includes no second tapered portion 34. Thus, the decrease degree of the cross-sectional flow area of the inlet pipe 30 in the second tapered portion 34 may be adjusted to obtain a uniform flow rate of the coolant flowing into the two containers 21.

### Advantages of the Present Embodiment

(1) The inlet pipe 30 includes the two inlet connection passages 35, the first tapered portion 33, and the second tapered portion 34. The second tapered portion 34 is in communication with the container 21B via the inlet connection passage 35.

The structure described above limits decreases in the ion exchanging efficiency of the ion exchanger 10.

In addition, in the structure described above, when the inlet pipe 30 is formed through injection molding, the first tapered portion 33 and the second tapered portion 34 each function as a draft angle of the second mold 85. This facilitates the removal of the second mold 85.

(2) The first tapered portion 33 is in communication with the container 21A via the inlet connection passage 35.

When forming the inlet pipe 30 through injection molding, a columnar second mold 85 needs to be prepared to form the inner surface of the inlet pipe 30. In an example, when the second tapered portion 34 is in communication with two or more containers 21 including the container 21B, the proportion of the second tapered portion 34 to the entirety of the inlet pipe 30 increases. Therefore, as compared with a structure in which the inlet pipe 30 includes no second tapered portion 34, the proportion of the portion of the second mold 85 that forms the inner surface of the second tapered portion 34, that is, the proportion of the second taper molding portion 87, is increased. This increases the region of the second mold 85 having the small cross-sectional area. As a result, the second mold 85 may have an insufficient strength and may be deformed by injection pressure of the resin R. This may adversely affect the moldability of the case 20 of the ion exchanger 10.

In this regard, in the structure described above, the second tapered portion 34 is in communication with the container 21B, and the first tapered portion 33 is in communication with the container 21A. Thus, the proportion of the second tapered portion 34 to the entirety of the inlet pipe 30 is decreased. This avoids the second mold 85 from having an insufficient strength. Therefore, while limiting decreases in the ion exchange efficiency of the ion exchanger 10, decreases in the moldability of the case 20 of the ion exchanger 10 are avoided.

(3) The portion of each bottom wall 22 forming the circumferential wall 31 of the inlet pipe 30 has a uniform thickness.

In the structure described above, the portion of the circumferential wall 31 of the inlet pipe 30 formed by each bottom wall 22 has a uniform thickness. Thus, when forming the inlet pipe 30 through injection molding, formation of a sink mark caused by variations in the thickness of the circumferential wall 31 of the inlet pipe 30 is limited.

(4) The inner spaces of the two inlet connection passages 35 are identical in shape and size to each other.

With the structure described above, a difference in the flow rate of the coolant flowing from the inlet pipe 30 between the two containers 21 is likely to depend on the decrease degree of the cross-sectional flow area of the inlet pipe 30 in the second tapered portion 34. The decrease degree of the cross-sectional flow area of the inlet pipe 30 in the second tapered portion 34 may be adjusted to readily adjust the flow rates of the coolant flowing into the two containers 21.

(5) The inner space of each inlet connection passage 35 extends further outward in the radial direction than the inner space of the first tapered portion 33 and the inner space of the second tapered portion 34.

In the structure described above, when each container 21 and the inlet pipe 30 are integrally molded by injection molding, the second molding portion 83, which forms the inner surface of the inlet connection passage 35, is greater in the radial direction of the inlet pipe 30 than the second mold 85, which forms the inner surface of the inlet pipe 30. Thus, the second molding portion 83 is arranged on each of the two first molding portions 82, which respectively form the inner surfaces of the two containers 21. In addition, each second molding portion 83 includes the fitting hole 83a or the fitting recess 83b, into which the second mold 85 is fitted. Injection molding is performed when the second mold 85 is fitted to the second molding portions 83. Thus, during injection molding, deformation of the second mold 85 due to the pressure of the resin R is limited. This limits decreases in the moldability of the case 20 of the ion exchanger 10.

### MODIFIED EXAMPLES

The present embodiment may be modified as described below. The present embodiment and the following modified examples can be combined as long as the combined modified examples remain technically consistent with each other.

The inner space of each inlet connection passage 35 does not have to extend further outward in the radial direction than the inner space of the first tapered portion 33 and the inner space of the second tapered portion 34. In an example, the inlet connection passage 35 may be a through hole that extends through the circumferential wall 31 of the inlet pipe 30 in the radial direction.

The inner spaces of the inlet connection passages 35 may differ from each other in shape and size.

The portion of each bottom wall 22 forming the circumferential wall 31 of the inlet pipe 30 does not have to have a uniform thickness.

The inner space of the inlet pipe 30 and the inner space of each container 21 does not have to be separated by the bottom wall 22. In this case, for example, the inlet pipe 30 may have a main passage including the first tapered portion 33 and the second tapered portion 34 and branch passages branched from the main passage. The branch passages are respectively open to the bottom walls 22 of the two containers 21. In the present modified example, each branch passage corresponds to a “connection passage.”

The second tapered portion 34 may be in communication with each of two or more containers 21 including the container 21B located at the most downstream side in the flow direction via the inlet connection passages 35.

The ion exchanger 10 may include three or more containers 21 arranged next to one another and three or more cartridges 40 respectively accommodated in the containers 21. In this case, for example, it is preferred that the second tapered portion 34 is in communication with the container 21 located at the most downstream side in the flow direction, and that the first tapered portion 33 is in communication with each of the remaining containers 21.

The first tapered portion 33 may be discontinuous with the second tapered portion 34. In an example, another tapered portion may be arranged between the first tapered portion 33 and the second tapered portion 34. In another example, a linear portion extending linearly along the axis of the inlet pipe 30 may be arranged between the first tapered portion 33 and the second tapered portion 34. When another tapered portion is arranged between the first tapered portion 33 and the second tapered portion 34, it is preferred that the decrease degree of the cross-sectional flow area of the inlet pipe 30 in the tapered portion increases toward the downstream side. When three or more containers 21 are arranged, it is preferred that the containers 21 are each connected to a different tapered portion.

The ion exchanger 10 is not limited to being applied to the coolant circuit C of the fuel cell and may be applied to various devices that need ion exchange of a coolant.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An ion exchanger, comprising:
containers arranged next to one another;
ion exchange resin portions contained in the containers, respectively; and
an inlet pipe extending in an arrangement direction of the containers and being configured to allow a coolant to flow to the containers, wherein
a direction of the coolant flowing through the inlet pipe is referred to as a flow direction,
each of the containers has a bottom wall,
the inlet pipe includes
connection passages arranged in correspondence with the containers, each of the connection passages being open through the bottom wall of a corresponding one of the containers to allow for communication between an inner space of the inlet pipe and an inner space of the corresponding one of the containers in a radial direction of the inlet pipe,
a first tapered portion having a cross-sectional flow area that decreases toward a downstream side in the flow direction, and
a second tapered portion arranged at the downstream side of the first tapered portion and having a cross-sectional flow area that decreases toward the downstream side,
the inlet pipe has a cross-sectional flow area having a decrease degree that is greater in the second tapered portion than in the first tapered portion, and
the second tapered portion is in communication with a container of the containers that is located at the most downstream side in the flow direction via a corresponding one of the connection passages.

2. The ion exchanger according to claim 1, wherein the first tapered portion is in communication with a container of the containers that is located at an upstream side of the container that is located at the most downstream side in the flow direction via a corresponding one of the connection passages.

3. The ion exchanger according to claim 1, wherein
the inner space of the inlet pipe is separated from the inner space of each of the containers by the bottom walls, and
the bottom walls each include a portion forming a circumferential wall of the inlet pipe and having a uniform thickness.

4. The ion exchanger according to claim 1, wherein
the inner space of the inlet pipe is separated from the inner space of each of the containers by the bottom walls, and
inner spaces of the connection passages are identical in shape and size to each other.

5. The ion exchanger according to claim 1, wherein an inner space of each of the connection passages extends further outward in the radial direction than the inner space of the first tapered portion and the inner space of the second tapered portion.
